(19) United States
(12) Patent Application Publication
(10) Pub. No.: US 2012/0244233 A1
(43) Pub. Date: Sep. 27, 2012

(54) COMPOSITIONS AND METHOD FOR CONTROLLING FUNGAL FOLIAR PATHOGENS

(76) Inventor: James LEAHY, JR., Quebec (CA)

(21) Appl. No.: 13/209,081

(22) Filed: Aug. 12, 2011

(30) Foreign Application Priority Data
Mar. 25, 2011 (CA) 2735319

(51) Int. Cl. A01N 59/02; A01P 3/00

(52) U.S. Cl. 424/705

(57) ABSTRACT

Pathogens including apple scab are controlled with the systematic application on fruit crops of organic compositions comprising yucca extract, elemental sulphur and salicylic acid.

### FIELD OF THE INVENTION

The present invention generally relates to plant pathogen control and more particularly to the control of pathogens in fruit crops, including apple scab.

### BACKGROUND OF THE INVENTION

Environmentally acceptable fungicide compositions are used by organic growers to control apple scab and other pathogens. Examples include elemental sulphur, such as KUMULUS™. Other fungicides comprise a yucca extract, such as those disclosed in WO/2007/139382 to Bengtsson et al.

However, compositions comprising as active ingredients elemental sulphur or yucca extract, alone or in combination, do not inhibit pathogens to such a degree where virtually all the pathogens are inhibited or eliminated. There remains a need for an organic composition and method for controlling fungal foliar pathogens in crops such as apple scab.

### SUMMARY OF THE INVENTION

The compositions described below comprise yucca extract, elemental sulphur and salicylic acid in various quantities, applied to apple crops by spraying. The observed result of systematic spraying, when compared to an adjacent apple field control group which was not sprayed were remarkable. All or almost all incidents of apple scab were inhibited or eliminated from the sprayed crops whereas the adjacent untreated control crop was destroyed by apple scab. In addition, a second adjacent crop which had minimal spraying had significant apple scab, although much less than the control group. The three active ingredients were mixed in the following ranges, in an aqueous solution, per hectare (ha) of crops.
Yucca: 4 L/ha-8 L/ha
Sulphur: 2 kg/ha-4 kg/ha
Salicylic acid: 185 g/ha-370 g/ha

It is an object of the present invention to provide compositions for controlling fungal foliar pathogens, including apple scab, wherein the compositions comprise elemental sulphur, salicylic acid; and yucca. Compositions can be in aqueous form for ease of application. If aqueous compositions are used, a suitable antifoam agent is mixed with the composition to account for the foaming properties of the yucca.

It is a further object of the present invention to provide compositions comprising sulphur in the range of 2 kg-4 kg, salicylic acid in the range of 185 g-370 g, yucca in the range of 4 L-8 L and water in the range of 750 L-1,000 L.

It is a further object of the present invention to provide a method of applying the compositions of the present invention to crops, including apple trees and grape vines. The compositions can be applied by foliar spraying. To maintain pathogen control throughout the season, a plurality of applications are done.

It is a further object of the present invention to provide organic compositions with reduced sulphur content for the control of apple scab.

### DETAILED DESCRIPTION OF THE INVENTION

Various cultivars of apples have different susceptibility to apple scab. For example, McIntosh and Spartan apples are very susceptible to apple scab, in comparison to Cortland apples. The compositions and methods of the present invention were tested for McIntosh, Spartan, Cortland and Ida Red cultivars, with excellent results.

While the tested crops were the specific apple cultivars, the compositions of the present invention and methods described herein will also inhibit fungal foliar pathogens in other apple cultivars, and in other fruit crops, including grapes, albeit with different relative amounts. Depending on the crop to be treated, the skilled worker having regard to this specification would optimize the amounts of each active ingredient.

The crops evaluated with the compositions and method of the present invention include four cultivars of apple, grown in the Quebec region of Canada. A first time to apply the compositions of the present invention was determined to be early in the growing season, between late April and late June, to coincide with the apple scab primary season. A second time to apply the compositions of the present invention is during the apple scab secondary season, from late June until August in the tested region.

The active ingredients in the compositions of the present invention are elemental sulphur, salicylic acid and yucca extract. The amounts of each active ingredient varied depending on the time of application and were optimized for the cultivars tested. Other amounts are contemplated, depending on the apple cultivar. In addition, active ingredients from other sources are also contemplated.

The sulphur tested was KUMULUS DF™ obtained from BASF Canada Inc. of Toronto, Ontario, Canada which is marketed as a water dispersible granular fungicide and acaricide. The product is guaranteed by the manufacturer to be 80% pure.

The salicylic acid tested was willow extract 25% obtained from Stryka Botanics of Hillsborough, N.J., USA. The product is a brown powder which is partly soluble in water. The product is guaranteed by the manufacturer to be 25% pure.

The yucca tested was BIOSOIL™ obtained from Agroindustrias El Alamo S.A. de C.V. of Baja California, Mexico. The product is a liquid which contains 97.0% botanical extract derived from the Yucca schidigera plant, 1.0% humic acid and 2.0% citric acid. It is marketed as a natural wetting agent, soil conditioner and plant growth promoter.

An antifoam non-active ingredient was also used during the mixing process given the foaming agent properties of yucca extract. Polydimethylsiloxane emulsion under the brand Antifoam OR-10™ was obtained from Momentive Performance Materials of Friendly, W. Va., USA. The product is a liquid and contains 10-30% silica filled polydimethylsiloxane, 60-90% water, 1-5% fatty acid ethoxylate, 1-5% fatty acid ester and 1-5% cellulosic thickener.

Various compositions were mixed in a 1,500 L sprayer tank water prior to application on apple trees per hectare in accordance with the methods specified below. Four embodiments are provided in Table 1 below.

TABLE 1
Composition Mixtures

| | 1 | 2 | 3 | 4 | 5 | 6 |
|---|---|---|---|---|---|---|
| Fungal Infection control | Primary | Primary | Primary | Second | Second | Second |
| Leaves fully open | No* | Yes | No* | Yes | Yes | Yes |
| Elemental sulphur (kg) | 4 | 4 | 4 | 2 | 2 | 4 |
| Salicylic acid (kg) | 0.370 | 0.370 | 0.350 | 0.185 | 0.185 | 0.330 |
| Yucca (L) | 8 | 8 | 8 | 4 | 4 | 8 |
| Antifoam agent (L) | 0.075 | 0.100 | 0.075 | 0.075 | 0.100 | 0.100 |
| Water (L) | 750 | 1,000 | 750 | 750 | 1,000 | 1,000 |

*Leaves either not yet present or not fully open

As can be seen, the compositions of the fourth and fifth embodiments comprised half the active ingredients of the compositions of the first and second embodiments, respectively. The fourth or fifth embodiments are applied to the crops if it is determined that there was no primary infection after proper application of the first or second embodiments, respectively. Primary infection may occur despite the application of the first or second embodiments for a number of reasons independent of the invention, including human error during application or excessive rain.

The compositions of the third and sixth embodiments, comprising 0.350 and 0.330 kg salicylic acid respectively, were also mixed with 4 kg elemental sulphur and 8 L yucca, then applied to crops and yielded excellent results for the tested cultivars.

Another composition, not shown in Table 1 comprised 0.300 kg salicylic acid mixed with 4 kg elemental sulphur and 8 L yucca. This composition was applied to three crop fields (8 sprays at 750 L/ha) after 4 initial sprays of a known composition with fair results. Based on this test, it was decided to only evaluate the compositions of the present invention.

All compositions were applied to various apple crops during the apple scab infection cycle. Unlike treatments by elemental sulphur alone which are susceptible to minor rainfalls, the compositions of the present invention did not wash away with less than an inch of rainfall.

### Application:

The compositions were applied by foliar spraying on the surface of the crops. For preventative spraying, the number of sprays are applied such that the exposed foliage, when grown, is covered continuously during the apple scab primary infection season. The skilled worker will appreciate the application protocol could be as often as every inch of rain, if there is an intense growth spurt, every seven days, etc.

TABLE 2
Example 1 on Three Fields: Compositions 1 and 4

| | Composition | |
|---|---|---|
| | 1 | 4 |
| Application (L/ha) | 750 | 1,000 |
| First Spray (T₀) | May 1 | n/a |
| Subsequent sprays from T₀ (d) | 4, 12, 23, 34, 37 | 47, 57, 73, 80 |
| Total applications | 6 | 4 |
| Average time between sprays (d) | 7.4 | 10.8 |

TABLE 3
Example 2 on Three Fields: Compositions 3 and 6

Composition

| | 3 | 6 |
|---|---|---|
| Application (L/ha) | 750 | 1,000 |
| First Spray (T₀) | May 12 | n/a |
| Subsequent sprays from T₀ (d) | 6, 14, 20, 27, 37 | 51, 62, 69 |
| Total applications | 6 | 3 |
| Average time between sprays (d) | 7.4 | 10.7 |

TABLE 4
Example 3 on One Field: Compositions 1 and 5

Composition

| | 1 | 5 |
|---|---|---|
| Application (L/ha) | 750 | 1,000 |
| First Spray (T₀) | May 1 | n/a |
| Subsequent sprays from T₀ (d) | 4, 12, 23, 34, 37 | 47, 57, 73 |
| Total applications | 6 | 3 |
| Average time between sprays (d) | 7.4 | 12.0 |

TABLE 5
Example 4 on One Field: Composition 3

| | Composition |
|---|---|
| | 3 |
| Application (L/ha) | 750 |
| First Spray (T₀) | May 12 |
| Subsequent sprays from T₀ (d) | 6, 14, 20, 27, 37, 51, 62 |
| Total applications | 8 |
| Average time between sprays (d) | 8.9 |

Among the apple trees treated with the compositions and methods of the present invention, all or virtually all apple scab was observed to be inhibited by harvest time.

In Examples 2 and 3 (Tables 3 and 4, respectively), compositions with less water were sprayed during the primary infection season for the first five applications as there were few or no leaves on the trees. Compositions with more water were then sprayed for the remaining applications as more foliage grew so that the leaves could be adequately coated during application. As the change in compositions coincided with the end of the primary infection season, the compositions sprayed during the secondary or summer season were effective.

As seen in the tables, 6-8 sprays were required during the season. More applications may be required during the primary season. When little or no primary infection was observed, up to 4 applications were used during the secondary or summer season. The spray frequency was every 7-12 days for the tested orchards. If primary scab infection is controlled during the primary season by the application of the compositions of the present invention, no application may be required during the summer season as there will be no secondary infection.

Comparison with Control and Crops Treated Less Often:

In two fields, samples were visually evaluated for primary and secondary apple scab infection, calyx-end rot and sooty mold in an organic apple orchard comprising three cultivars.

In a first sample, eight hundred apples of McIntosh, Spartan and Cortland cultivars were treated, 400 apples from the field of Example 3 (Compositions 1 and 2) and 400 apples from one of the three fields of Example 1 (Compositions 1 and 4). In a second sample from one field, one hundred Cortland apples in an orchard adjacent to the first sample were tested.

The apples of the second sample were treated only at the beginning of the growing season. A control group was used comprising thirty untreated Cortland apples in an orchard adjacent to the fields comprising the treated apples. Given their proximity, the evaluated apples were subjected to the same meteorological conditions.

The apples were evaluated after the apple scab infection cycle (late April to late June for the area tested). From the first sample, only one of 800 apples of Spartan cultivar (0.1%) was observed to have secondary scab. No Cortland or McIntosh apples from the first sample had any scab. From the second sample, 28 of 100 apples (28%) had primary or secondary scab. From the control, 26 of 30 apples (87%) had primary or secondary scab.

Apples treated with the compositions and methods of the present invention had virtually no damage from scab in comparison with untreated apples and apples with reduced treatment.

With the compositions of the present invention, it was found an organic grower uses up to six times less elemental sulphur per hectare of treated crops compared to prior art pathogen control protocols using sulphur alone. In addition, the compositions and methods of the present invention were determined to be as effective as non-organic alternatives, including Manzate Pro-Stick™. As such, the compositions of the present invention are suitable for application to control fungal foliar pathogens in organic crops as well as conventional, non-organic crops.

Based on the results achieved, the three active ingredients in the compositions of the present invention work together to effectively control fungal foliar pathogens in crops, compared to prior art applications of sulphur alone, yucca extract alone, or mixtures of yucca extract and sulphur.

Although the description above contains many specific details, these should not be construed as limiting the scope of the embodiments but as merely providing illustrations of some of the presently preferred embodiments. Thus the scope of the embodiments should be determined by the appended claims and their legal equivalents, rather than by the examples given.

1. A composition for controlling fungal foliar pathogens, comprising: elemental sulphur, salicylic acid; and yucca extract.

2. The composition of claim 1 in aqueous form.

3. The composition of claim 2 further comprising an antifoam agent.

4. The composition of claim 1 wherein said pathogens include apple scab.

5. The composition of claim 2 for applications at 750-1,000 L/ha on crops comprising 2-4 kg elemental sulphur, 185-370 g salicylic acid, 4-8 L yucca mixed in 750-1,000 L water.

6. The composition of claim 5 further comprising 0.075-0.100 L of antifoam agent.

7. A method of controlling fungal foliar pathogens in crops by applying to said crops an aqueous composition of elemental sulphur, salicylic acid and yucca extract.

8. The method of claim 7, wherein said composition further comprises an antifoam agent.

9. The method of claim 7, wherein said applying step is by foliar spraying.

10. The method of claim 9, wherein said spraying is repeated at least once during the pathogens' primary infection season.

11. The method of claim 10, wherein said spraying is repeated a plurality of times.

12. The method of claim 11, wherein said spraying is repeated every 7-12 days.

13. The method of claim 7, wherein said crops are selected from the group consisting of apple trees, other fruit trees and grape vines.

14. The method of claim 13 wherein said crops are organic crops.

15. The method of claim 13 wherein said crops are non-organic crops.

16. The method of claim 13, wherein said elemental sulphur is in the range of 2 kg-4 kg per hectare of crops.

17. The method of claim 13, wherein said salicylic acid is in the range of 185 g-370 g per hectare of crops.

18. The method of claim 13, wherein said yucca is in the range of 4 L-8 L per hectare of crops.
